(19) United States
(12) Patent Application Publication
(10) Pub. No.: US 2015/0119002 A1
(43) Pub. Date: Apr. 30, 2015

(54) METHOD AND APPARATUS FOR PHONEBOOK-BASED APPLICATION SHARING

(71) Applicants: Xiantao Chen, Beijing (CN); Yongguang Guo, Beijing (CN); Ying Liu, Beijing (CN)

(72) Inventors: Xiantao Chen, Beijing (CN); Yongguang Guo, Beijing (CN); Ying Liu, Beijing (CN)

(73) Assignee: NOKIA CORPORATION, Espoo (FI)

(21) Appl. No.: 14/241,421

(22) PCT Filed: Aug. 30, 2011
(86) PCT No.: PCT/CN2011/079090

§ 371 Date: Nov. 26, 2014

(51) Int. Cl. H04M 1/725; H04W 4/00

(52) U.S. Cl. CPC H04M 1/72522; H04W 4/003
USPC 455/414.1

(57) ABSTRACT

An approach is provided for determining one or more items installed on one or more devices. The one or more devices process and/or facilitate processing of the one or more items to cause, at least in part, an association of the one or more content items with respective contact entries associated with the one or more devices, one or more users of the one or more devices, or a combination thereof. Consequently, the one or more devices may cause, at least in part, a rendering of one or more representations of the one or more items in a contact-based user interface based, at least in part, on the association.

### BACKGROUND

Service providers and device manufacturers (e.g., wireless, cellular, etc.) are continually challenged to deliver convenience to consumers by, for example, providing compelling network services. One area of development has been the development of means for facilitating communications among connected users. For example, if is noted that the number and variety of mobile platforms available (e.g., Symbian, iOS, Android, WebOS, etc.) has increased greatly. At the same time, it is noted that there are a huge amount of mobile applications available. However, there lacks an efficient and easy way for users to find interesting, useful, and/or popular mobile applications to install and use. For developers, the increasing number of mobile applications available presents significant challenges to marketing or advertising their particular installed items to consumers. Accordingly, service providers face significant technical challenges to facilitating mobile application sharing efficiently, especially across platforms.

### SOME EXAMPLE EMBODIMENTS

Therefore, there is a need for an approach for providing sharing of items installed on one or more devices.

According to one embodiment, a method comprises determining one or more items installed on one or more devices. The method also comprises processing and/or facilitating processing of the one or more items to cause, at least in part, an association of the one or more items with respective contact entries associated with the one or more devices, one or more users of the one or more devices, or a combination thereof. The method further comprises causing, at least in part, a rendering of the one or more representations of the one or more items in a contact-based user interface based, at least in part, on the association.

According to another embodiment, an apparatus comprises at least one processor, and at least one memory including computer program code for one or more computer programs, the at least one memory and the computer program code configured to, with the at least one processor, cause, at least in part, the apparatus to determine one or more items installed on one or more devices. The apparatus is also caused to process and/or facilitate processing of the one or more items to cause, at least in part, an association of the one or more items with respective contact entries associated with the one or more devices, one or more users of the one or more devices, or a combination thereof. The apparatus is further caused to cause, at least in part, a rendering of the one or more representations of the one or more items in a contact-based user interface based, at least in part, on the association.

According to another embodiment, a computer-readable storage medium carries one or more sequences of one or more instructions which, when executed by one or more processors, cause, at least in part, an apparatus to determine one or more items installed on one or more devices. The apparatus is also caused to process and/or facilitate processing of the one or more items to cause, at least in part, an association of the one or more items with respective contact entries associated with the one or more devices, one or more users of the one or more devices, or a combination thereof. The apparatus is further caused to cause, at least in part, a rendering of the one or more representations of the one or more items in a contact-based user interface based, at least in part, on the association.

According to another embodiment, an apparatus comprises means for determining one or more items installed on one or more devices. The apparatus also comprises means for processing and/or facilitating processing of the one or more items to cause, at least in part, an association of the one or more items with respective contact entries associated with the one or more devices, one or more users of the one or more devices, or a combination thereof. The apparatus further comprises means causing, at least in part, a rendering of the one or more representations of the one or more items in a contact-based user interface based, at least in part, on the association.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-20 and 36-38.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of sharing installed items, according to one embodiment;

FIG. 2 is a diagram of the components of the components of user equipment, according to one embodiment;

FIG. 3 is a flowchart of a process for determining and using a contact-based user interface for sharing installed items, according to one embodiment;

FIG. 4 is a flowchart of a process for utilizing a contact-based user interface for sharing installed items;

FIGS. 5A-7B are diagrams of user interfaces utilized in the processes of FIGS. 3 and 4, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for sharing installed items are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

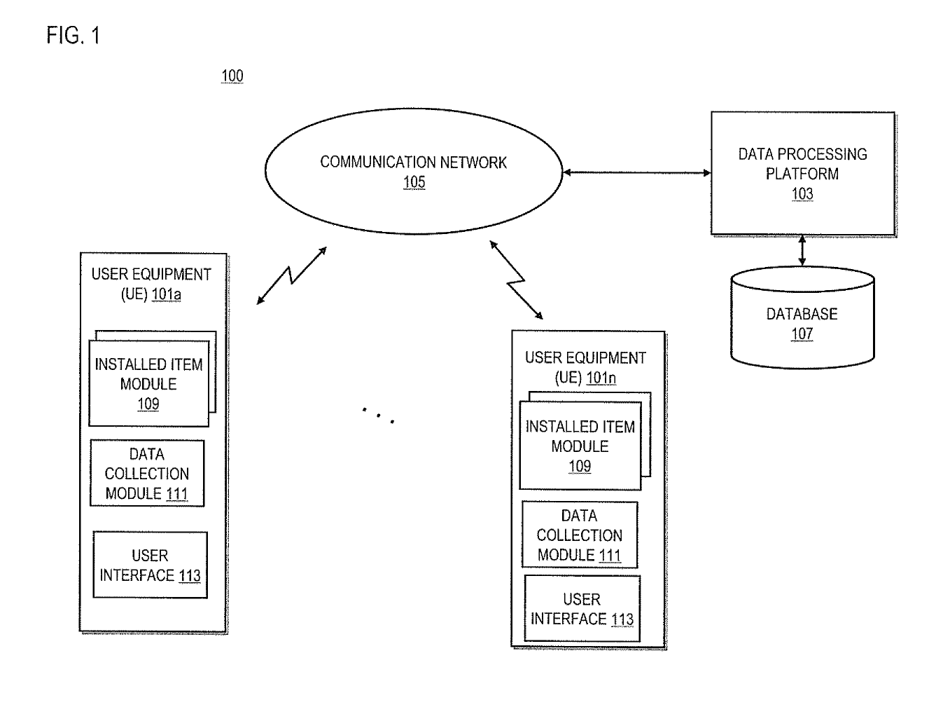

FIG. 1 is a diagram of a system capable of phonebook-based application sharing according to one embodiment. Traditionally, there are many mobile applications available, however, there lacks an efficient, easy way for users to find interesting and/or popular mobile applications to install and use. Plus, with different mobile platforms such as Symbian, iOS, Android, WebOS, etc., cross-platform application sharing is an issue. Furthermore, applications developers lack marketing or advertising channels to expose their applications to consumers.

To address this problem, a system 100 of FIG. 1 introduces the capability to share items installed on one or more devices via a contact-based user interface. In one embodiment, the installed items are applications. The installed items may also include, at least in part, bookmarks, playlists, ringtones, personal settings, and device information such as device brand, type, operating system information, and/or device hardware information, or a combination thereof. Additionally, sharing of the installed item may be based on and integrated with the phonebook or other listings of real contacts or social networks of the user. In such a scenario, contacts in the phonebook and those in the social networks may be integrated to make a comprehensive listing that may form the basis of sharing.

System 100 may also provide auxiliary information to supplement user knowledge of the item and better facilitate sharing of installed items. In the example where the installed item is an application, such auxiliary information may include information associated with contacts or general information on the installed item. For instance, information associated with contacts may include, at least in part, usage information specific to a contact. Usage information may include, at least in part, the total time that the user (and contact) has been using the application, frequency that the user has used the application, average usage time each day, usage specific to the content item itself, user comments, and user ratings. General information covers information not specific to the contact such as, at least in part, the installed item's price, compatibility, related applications, or some combination thereof.

As shown in FIG. 1, the system 100 comprises a user equipment (UE) 101 having connectivity to data processing platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

Moreover, the data processing platform 103 may receive information regarding items installed on the one or more devices, and store the information in database 107. The database 107 can include identifiers to each UE 101 as well as associated information. Further, the information may be any one of multiple types of information that can provide means for creating a rendering of the information in a contact-based user interface. The database 107 may store information from the installed item module 109 and/or data collection module 111 as processed through the data processing platform 103.

In one embodiment, individual UEs may collect, via the installed item module 109, inventory of the installed items to determine one or more items installed on one or more devices. For example, UE 101 may use installed item module 109 to keep track of items installed and/or removed from UE 101. In other words, UE 101 may determine one or more items installed on one or more devices. In a further example, installed item module 109 may process and/or facilitate processing of the one or more items to cause, at least in part, an association of one set of installed items with another. One instance of such an association is associating web-based applications with entries in native applications installed on the same device, such as associating a web-based application with contact entries in the user's phonebook, a native application. Alternately, an association may be formed between native applications, such as associating playlists with contact entries in the user's phonebook.

User interface 113 on one of the UEs 101a associated with a user can then utilize the information sorted on the data processing platform 103 to generate a display. In one embodiment, user interface 113 may act after the installed item module 109 to directly create a rendering based on associations made from the installed item module 109. Alternately, the data collection module 111 may engage after the installed item module 109, before the user interface 113 is triggered. In this alternate embodiment, installed item module 109 may determine the one or more items installed on UE 101 and have the data collection module 111 provide data regarding the installed items before the user interface 113 is output. Data collection module 111 may determine data concerning the items, such as data regarding item popularity or compatibility with the UE 101. The information may be transmitted via communication network 105 between UEs 101 and the data processing platform 103. The data processing platform 103 may receive the input and may associate the input as a query associated with the UE 101a as to what to display on the user interface 113.

In one embodiment, user interface 113 is a contact-based user interface. For instance, the contact-based user interface may be the phonebook of one or more devices. The contact-based interface may also be the integration of several contact-based applications, such as a compiled listing comprised of entries in a device phonebook and various social networking service entries.

The information in the database 107 can be continuously changing, thus, once the input request is received, the data processing platform 103 continuously or periodically update data and displays input request. As such, the user may specify parameters for the data processing platform 103 to update the UE 101a of changes to the installed items. In certain embodiments, the data processing platform 103 can monitor the UEs to determine the one or more installed items, wherein the monitoring is performed periodically, according to a schedule, on demand or a combination thereof. Then, the data processing platform 103 can update the requested displays based on the one or more updates.

In one example, the user may specify a request for seeing “Apps on my friends' device” where the installed item module 109 and data collection module 111 retrieve data regarding shared applications of his/her contacts from one or more servers. In one embodiment, the request may yield a user interface 113 with all the user's contacts, along with the representative icons of the contacts' most frequently accessed applications alongside each contact name. From there, the user may have the option to expand a dropdown display to show all of a particular contact's applications, for instance, as in the form of representative icons. Furthermore, selecting a particular representative icon may lead to a display containing more information on the application of the icon. The information may come from the data processing platform 103 and/or the data collection module 111, and include, at least in part, the name of the application, application price information, ratings, comments, and usage history.

In another embodiment, the UE 101 may display the most popular applications within a grouping of contacts. For instance, contacts may be organized into groups such as, “Friends”, “Classmates”, “Family Members”, “Colleagues”, etc. In this embodiment, UE 101 may have a user interface 113 displaying the representative icons alongside the group name for the applications most popular with the contacts in the group. Again, the user may have the option to select an expanded view with more popular applications according to the group. Also as previously discussed, the user may opt to view more in-depth information on applications.

Following on the previous embodiments, contacts may have privacy options regarding what applications to share, and what not to share. For example, as the user interface 113, there may be a field or section in each contact's record in the phonebook called “My Applications” or “Applications on My Device”, where applications of the contact are displayed. From there, the contact may select settings for application sharing. For instance, there may be a shared application list that the contact may populate with a subset from the contact's collective applications. The contact may directly select the applications he/she would like to share amongst his/her list of detected applications. Alternately, a contextual menu may appear when the contact clicks on the icon or shortcut of a specific application with an option such as, “Share this app to my contacts.” Selecting such an option may cause the application to enter the shared list. In some cases, the contact may prefer sharing application information with some contacts or contact group(s), but not all the members of their phonebook. System 100 may then have an embodiment permitting the contact to select the contacts or contact groups to which particular application material is shared. Again, the applications may be shown simply using identification information such as a representative icon or name. In some embodiments, the displayed application may be accompanied by information about the application as provided by the data collection module 111. Such information may include, at least in part, the application's price information, rating, comments, and/or general usage statistics.

In some embodiments, an “App view” is provided, wherein all the applications shared by the user's contact entries are listed. The list may be sorted by application name, number of users sharing the application, etc. For each application, the user may see how many other users have shared it and with whom. In another exemplary embodiment, for each application shared, a user may see a list of his/her contacts who have shared the same application and the application usage information of each respective contact. Lastly, such a sorting of applications by contact entry may permit an embodiment where a user may search applications by contacts.

In another embodiment, when developer make applications available for download (e.g., in application stores), the developers may ask for users who would like to help them advertise and/or distribute their applications via their respective device phonebooks as described in the various embodiments discussed herein. In some embodiments, developers or other providers can optionally set criteria for the recruitment of users (e.g., for advertising on distribution purposes) for their applications or other items. For example, criteria may be used to select users who have already used the applications for some time. The system 100 can then search for the users and transmit one or more notifications requesting that they participate in such an advertising or distribution program. The users can then enroll themselves in the advertisement program and the application of interest can be shared in their devices' phonebooks to other users. In one embodiment, the application can be placed in the phonebook or contact lists as another entry (e.g., with the entry designated by the application's icon). In another embodiment, the developers may offer incentives or other awards (e.g., free use of the application, additional levels, badges, etc.) for participating in the advertising program. In one embodiment, providers or owners of the application stores may operate the advertising or distribution program. However, it is contemplated that any other party (e.g., service providers, developers, third parties, publishing houses, etc.) may also operate the program independently or in cooperation with the application store owners.

By way of example, the UE 101, data processing platform 103, and database 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data, Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

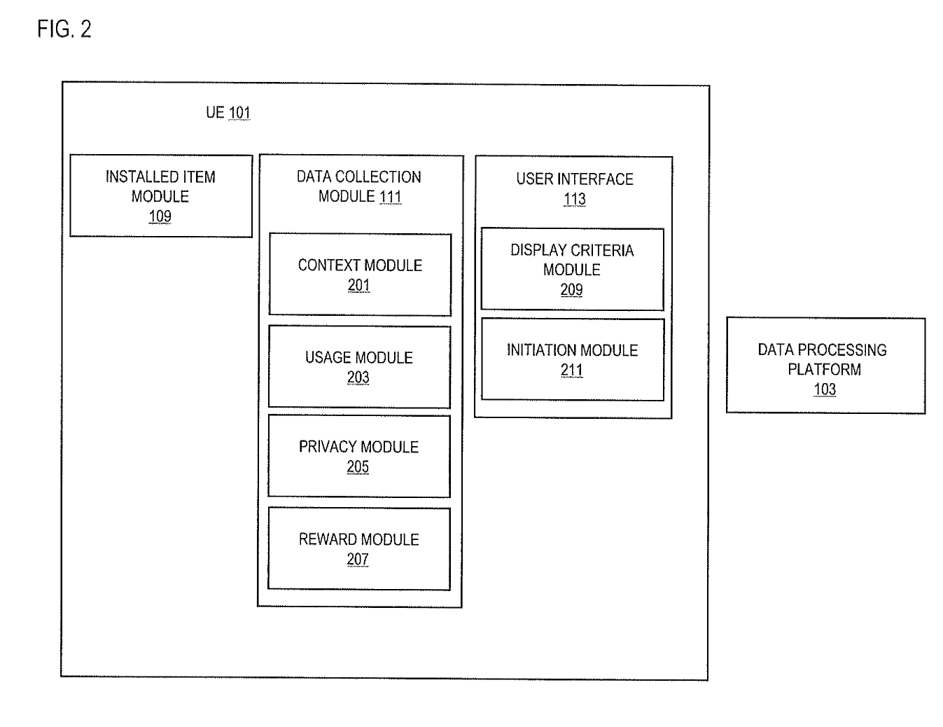

FIG. 2 is a diagram of the components of UE 101 according to one embodiment. By way of example, the UE 101 includes one or more components for providing sharing of installed items. It is contemplated that the functions of these components may be combined in one or more components or performed by other components of equivalent functionality. In this embodiment, the UE 101 includes, at least in part, an installed item module 109, data collection module 111, and user interface 113. Periodically, the information may be transmitted to the data processing platform 103 to filter the data from the data collection module 111 through the display criteria module 209.

Installed item module 109 identifies or determines one or more items installed on the one or more devices. From there, the data collection module 111 may go on to find data regarding the identified installed items that may be of interest to the user. The data collection module 111 may primarily cover data that is not directly controlled by the user of the one or more devices. In one exemplary embodiment, the data collection module 111 includes, at least in part, the context module 201, the usage module 203, the privacy module 205, and an optional reward module 207. In one scenario, the context module 201 may determine data about the installed item that is not necessarily associated with one or more contact entries in the phonebook. For instance, the context module 201 may find: price, an overview, file size, general popularity, screenshots, demos, developer information, market content, related items that may be installed, compatibility with the device, related or relevant advertisements, etc. General popularity may refer to ratings and recommendations by the general public, for instance via a 5-star based system or user reviews.

The usage module 203 may provide data on a specific contact's interaction, or usage history, with the installed item. For instance in one embodiment, usage data may include, at least in part, total time the user has been using the application, frequency that the user has used the application (e.g. twice a day on average), and/or average usage time each day. In an additional embodiment, the data determined by the usage module 203 may be specific to the application itself. For example, in mobile microblogging applications, the number of tweets posted by a user may be shared. The usage module 203 may also include data regarding ratings and comments given by the contacts. Between the opinions and actual item usage of contact, the user may better form an unbiased idea of the installed item. Lastly, the usage module 203 may track usage information in order to update the information to reflect the latest usage information.

The privacy module 205 may filter out any information that contacts prefer to not be shared. In one embodiment, the privacy module 205 may block any installed items that contacts select not to share so that those installed items are not later displayed. In another embodiment, the privacy module 205 may block information about the installed item. For instance, a contact may not want to share all the usage data in detail, out of privacy concerns. In such a scenario, the contact may have the option to select the usage information to share for a specific installed item. In one embodiment, the usage information may be “blurred” when it is shared.

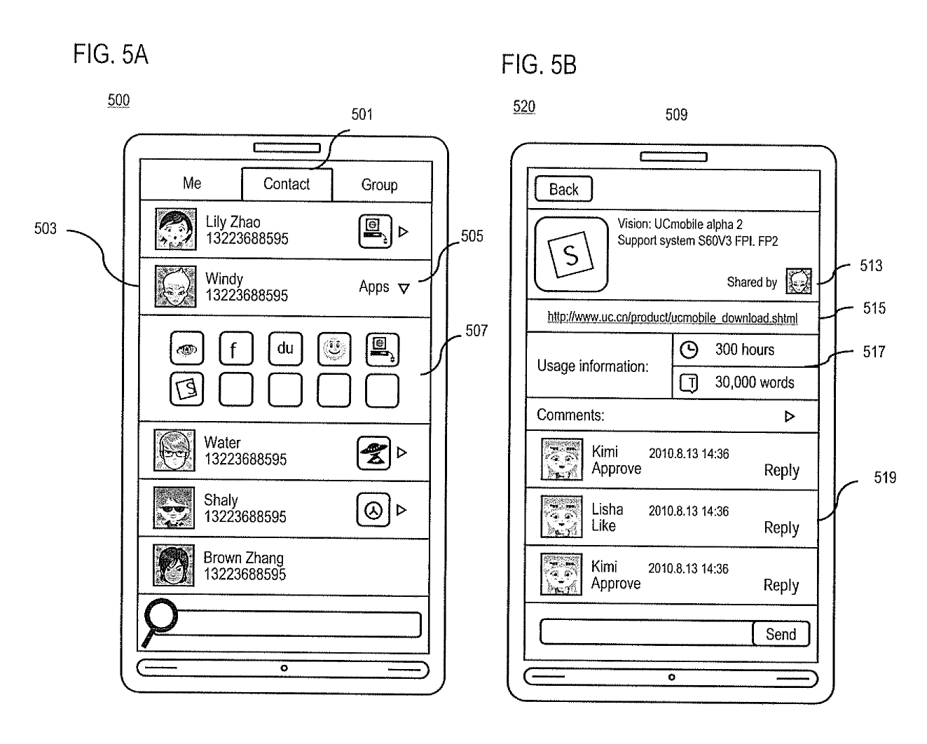

The reward module 207 may the UE 101's sharing and reward “points” for it. For instance, the points may be used as virtual money or a discount for installing more items. In other embodiments, the user may receive “badges”, e.g. based on the items they share, the number of items his/her contact has installed/purchased through is/her sharing. The reward module 207 may also permit the user to receive some award from item developers for helping to bring attention to the installed item through the sharing.

Whereas the user may not directly control the data of the data collection module 111, the user may have direct command over the user interface 113. The user interface 113 may process data gathered from the data collection module 111 to display data relevant to the user, in a rendering chosen by the user. To do this, the user interface 113 may include, at least in part, the display criteria module 209, and the initiation module 211 as means for causing presentation of contact-based sharing of installed items. Example user interfaces of such grouping queries, results, and actions performed as part of the results are shown in FIGS. 5-7B.

The display criteria module 209 may sort data provided by the data collection module 111 based on criteria set by the user. Some examples of such criteria are: temporal, based on search terms, or based on groupings of the contact entries. In one possible example of a temporal criteria display, display criteria module 209 may permit a rendering of the newly installed items from contacts in a user's contact list. Another possible temporal criterion may request a showing of the installed item most recently used by members of a contact list, A criteria of search terms may cause display criteria module 209 to sort data from the data collection module 111 based on categorical terms, such as “games”, “references”, “travel”, “news”, “social networking”, “lifestyle”, “personal assistance”, “connectivity” or “locator”, etc. As for groupings of the contact entries, one instance may be where the user opts to see the most popular application, or other installed item, shared by all the contacts in his/her phonebook. An alternate example of a grouping display criterion may be where the user chooses to display the most popular applications within a specific contact group in the phonebook. The display criteria module 209 sorts data into the display selected by the user to generate the rendering for user interface 113.

The display criteria module 209 may receive the display criteria via the initiation module 211. The initiation module 211 may include various methods of communication and respond to contact from the user to move from one display to another. For example, the initiation module 211 may have input from a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc. As discussed above, the user interface 113 may have multiple embodiments and forms of output. One common embodiment of a user interface 113 may include a visual component (e.g., a screen). Example user interfaces of such grouping queries, results, and actions performed as part of the results are shown in FIGS. 5-7B.

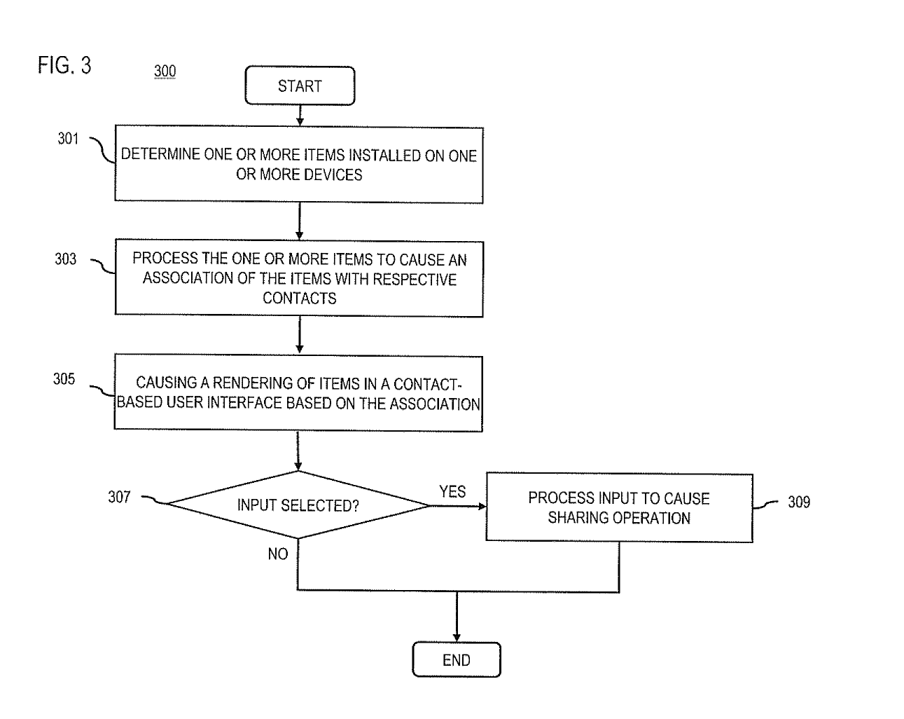

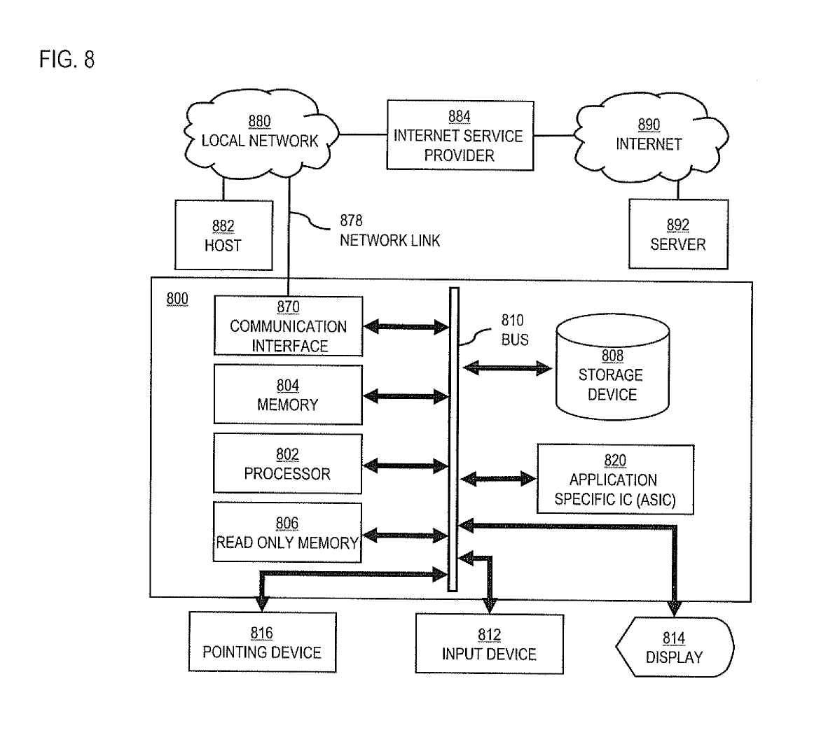

FIG. 3 is a flowchart of a process for determining one or more items installed on one or more devices, according to one embodiment. In one embodiment, the UE 101 performs the process 300 and is implemented in, for instance, a chip set including a processor and a memory as shown in FIG. 8. As such, the data processing platform 103 can provide means for accomplishing various parts of the process 300 as well as means for accomplishing other processes in conjunction with other components of the data processing platform 103 and/or UE 101. Throughout this process, the data processing platform 103 is referred to as completing various portions of the process 300, however, it is understood that the UE 101 can perform some of and/or all of the selected process steps.

In step 301, installed item module 109 of UE 101 may determine one or more items installed on one or more devices. The installed items may include, at least in part, applications, bookmarks, playlists, ringtones, personal settings, device information, or some combination thereof. As previously noted, the data processing platform 103 may receive updates of installed items and installed item information from the other UEs 101 as well as the UE 101a. The installed item updates and information can be collected at each of the UEs 101 and developers, then transmitted to data processing platform 103. By way of example, information regarding the UEs 101 (e.g., device type, operation system type and version, hardware information, etc.) can be retrieved and sent to the data processing platform 103. In addition, identification information of the one or more installed items (e.g., application identification number, application name, etc.) may also be sent to the platform 103 for processing.

In one embodiment, the other UEs 101 associated with the UE 101a can be selected in various manners. In one example use case, the other UEs 101 can be contacts in a phonebook associated with the UE 101a. In another embodiment, the other UEs 101 can be otherwise associated with the UE 101a (e.g., a member of the same group) or be part of a public community. For example, the UEs 101 can be part of a real-time opportunistic community designed to share context information to provide users with the ability to contact each other. A real-time opportunistic community can refer to a group of people constituted dynamically (i.e., members of the group can change at any time) and have context attributes (e.g., volatile attributes) that match conditions specified by the criteria.

At step 303, the data processing platform 103 may receive the determined installed items and process the one or more items to cause an association of the items with respective contacts. For example, step 303 may be the initial and most basic association between the contact and the one or more installed items. The association between the contact and the installed items is simply to tie the data together. In one embodiment, the association between the contact and the installed items may not independently provide any further information beyond associating contact with installed item.

In one embodiment, the user interface 113 proceeds to cause, at least in part, a rendering of one or more representations of the one or more items in a contact-based user interface, based, at least in part on the association (step 305). Based on the specific capabilities of the UEs 101 (e.g., specific device hardware and/or software information) and/or identifiers associated with the items determined to be installed on the UE 101a, the data processing platform 103 may provide to the user interface 113 with a link or other identifier for selecting versions of the items (e.g., applications) appropriate to the one or more other UEs 101. For example, a URL link of a Symbian version of the application on the Ovi application store is provided for Symbian-based devices, while a URL link of the iOS version of the application on the iTunes application store is provided for iPhone devices. In some cases, the URL links may point to developer sites or other software repositories for obtaining the appropriate version of the application. The user interface 133 may then, for instance, render the links for selection or access by device. In this way, the data processing platform 103 enables different devices to obtain links to the appropriate versions of the installed items for their devices.

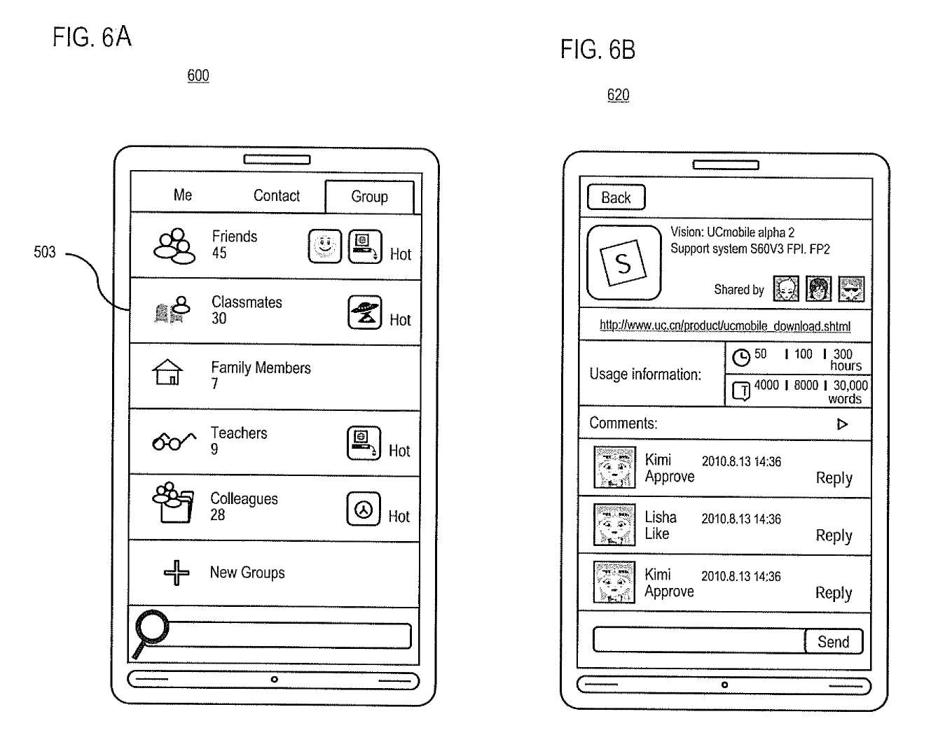

In one embodiment, the user interface 113 may yield a direct listing of applications associated with each contact, as depicted in FIGS. 5-6. Although subsequent steps, in one embodiment, are contingent on the association done in step 303, the user interface 113 may also be output by step 305 and/or may alternately involve more layers of processing. For instance, the output of step 305 may be contingent on meeting pre-set criteria provided by the display criteria module 209 and/or newly input criteria via the initiation module 211. In an additional embodiment, the data processing platform 103 and display criteria module 209 may process and/or facilitate processing of the contact entries associated with the one or more devices, the one or more users of the one or more devices, or a combination thereof into one or more groups, wherein the rendering is based, at least in part, on the one or more groups.

In one such scenario, the UE 101 may receive an input for selecting at least one of the one or more representations in the contact-based user interface (step 307). The input may be provided from the initiation module 211 of the user interface 113, where the user may go from the initially rendered contact-based user interface, to another interface. The next user interface may provide more information on the installed item. Step 307 may include the data collection module 111 and user interface 113 determining usage information, one or more display criteria, one or more privacy policies, or a combination thereof, wherein the rendering of the one or more representations, the contact-based user interface, or a combination thereof is based, at least in part, on the usage information, the one or more display criteria, the one or more privacy policies, or a combination thereof. As previously discussed, the usage information includes, at least in part, the total time that the user has been using the application, the frequency that the user has used the application, average usage time each day, usage specific to the installed item itself, or a combination thereof.

From there, the data processing platform may process the input to cause, at least in part, one or more sharing operations (step 309). Sharing operations may include, at least in part, a rendering, an option to share the item, buying the item, or some combination thereof. Step 309 may include the data processing platform 103 and data collection module 111 processing and/or facilitating a processing of the one or more items to cause installation of the one or more items, wherein the processing is based, at least in part, on the compatibility of the material with the one or more devices. In a further embodiment, step 309 may include data processing platform 103 determining advertising information, one or more related items, or a combination thereof based, at least in part, on the association, wherein the rendering, the contact-based user interface, or a combination thereof include, at least in part, the advertising information, the one or more related items, or a combination thereof. This step of adding advertisement and/or related items may optionally be included in other discussed renderings.

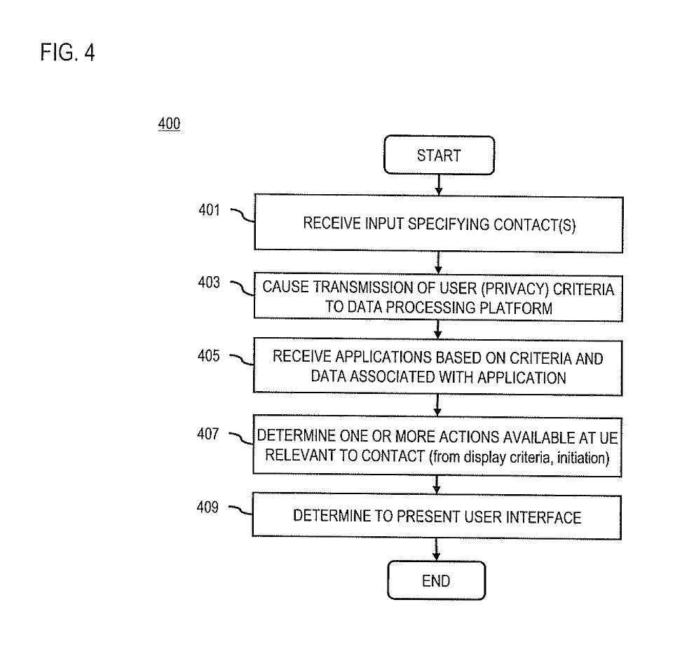

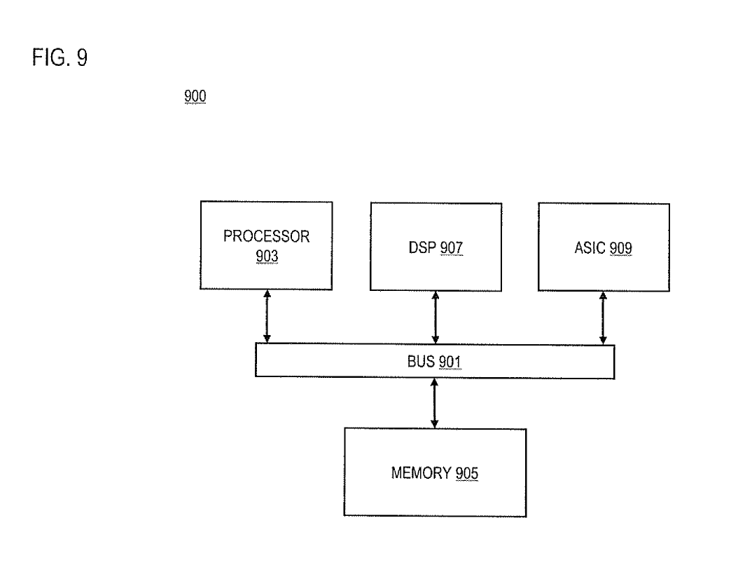

FIG. 4 is a flowchart of a process for utilizing phonebook-based installed item sharing. In one embodiment, the UE 101 performs the process 400 and is implemented in, for instance, a chip set including a processor and a memory as shown in FIG. 9. As such, the UE 101 can provide means for accomplishing various parts of the process 400 as well as means for accomplishing other processes in conjunction with other components of the UE 101. Additionally or alternatively, the data processing platform 103 may perform one or more aspects of the process 400.

In step 401, UE 101 receives input specifying one or more contacts to determine which UEs to collect installed item information from. The UE 101 may receive the input from the user interface 113. Example user interfaces used to specify criteria are provided in FIGS. 5A-C. As previously noted, the contacts can include, for example, one contact or a grouping of contacts.

At step 403 of one embodiment, the UE 101 causes, at least in part, transmission of the contact privacy criteria to the data processing platform 103. In one instance, the privacy criteria can be sent as a query requesting the applications that may be shared. Such a scenario is predicated on various users having the option to publish or share applications installed on his/her mobile devices via his/her phonebook. For example, in one possible embodiment, there may be a section in the phonebook where a user may input and edit his/her own profile information, which may for example be called “My profile” or “My contact card.” Such profiles may contain sub-sections where the user may select the applications to be shared. These sub-sections may for example be called “Apps on my device” or “My shared application list.” Making such settings as users translates into what is shared when the user is a contact with respect to other users.

Again, there might be different ways for a user to selectively share applications to their contacts. In one embodiment, the installed item module 109 of the mobile device may detect all the (3^{rd} party) mobile applications installed on the device. The detected installed applications may then be displayed for user to choose which ones they would like to share. In another embodiment, a menu may be displayed when a user clicks on the icon or shortcut of a specific application, with an option such as, “Share this app to my contact”, through which the user may add the specific application to his “Shared application list.” The user may additionally have the option of sharing the applications or application information with only some of his contacts or contact group(s), rather than all the contacts. In an additional possible embodiment, the user may upload the shared list onto a server after selecting the applications to share and settings associated with the sharing. Users with shared applications may determine what their display as contacts.

Once the contacts' privacy settings have been determined with respect to the user, in one embodiment, the UE 101 may receive applications that have been shared by the contacts. For example, in step 405, the UE 101 may receive applications based on what contacts choose to share with the user, as well as data associated with the application. For example, the UE 101 in conjunction with the data processing platform 103 may retrieve the data regarding the shared applications of his/her contacts from the server. As previously mentioned, in one embodiment, the data regarding the shared application may include the application's price, rating, general comments, demos, and/or screenshots, as well as usage history data describing the relationship between the contact and the application.

At step 407, in one embodiment, the UE 101 then applies preferences set by the user regarding the user interface to generate the user interface. For instance, this may include criteria given by the display criteria module 209 or commands from the initiation module 211 as received by UE 101. Examples of display criteria may include display by contact group, most popular applications, most recently installed applications, highest rated applications, most shared applications, etc. In step 409, the UE determines to present the user interface 113 with data provided by the data processing platform 103, installed item module 109, and data collection module 111, and limited by the privacy module 205, display criteria module 209, and initiation module 211, Sample user interfaces of such selections are shown in FIGS. 5-7.

FIGS. 5A-7B are diagrams of user interfaces utilized in the processes of FIGS. 3 and 4, according to various embodiments. With these displays, the user interface may display, in one embodiment, the most popular applications shared by all the contacts in a give phonebook, or the most popular applications in a specific contact group in the phonebook. In FIG. 5A, user interface 500 is comprised of a display of installed items may be formed in the template of the phonebook 501. In one embodiment, the phonebook includes multiple contact entries 503. In such an instance, each contact entry 503 may include the option to access types of information shared by a contact entry 503. One possible type of information shared by the contact entry 503 may be the applications installed 505 on the one or more devices of contact entry 503. For instance, there may be a section in the each contact's entry in the phonebook called, “Applications”, where applications shared by that contact are shown. As such, there may be the option to display the applications installed 505. One exemplary display may be a collection of icons 507 representative of their respective applications. As previously discussed, such icons 507 or display may be monitored and updated. Also, the display of application icons 507 may be contingent on display criteria, such as most recently used, most recently installed, most often used, etc.

User interface 520 in FIG. 5B may be the display generated after icon 507 is selected. This user interface 520 is primarily to provide the user with information to help decide whether to install the application, as well as information needed to easily download the application. Such a display may include information regarding the application represented by application icon 507. In an exemplary rendering, user interface 520 includes application name 509, compatibility information 511, the associated contact(s) 513, download link 515, usage information 517, and comments 519. The associated contact(s) 513 may include the direct contact that led to user interface 520, or it may include all the contacts in the phonebook that share the selected application. The download link 515 may be a link for a version of the application compatible with the user's phone. Usage info 517 may include the hours spent by the contact(s) on the application, in addition to usage specific to the application. Comments 519, in one embodiment, include all comments made by anyone in the phonebook, along with the date and time that the comment was made and option to respond to the comment.

User interface 600 shown in FIG. 6A is an alternate display organized by group. Here, applications may be displayed alongside categories of contacts 601. In one embodiment, the applications displayed are the most popular within the group or category of contacts 601. In another embodiment, the applications displayed may be the most recently installed amongst the contacts in the groups of contacts 601. The user may select the display criteria via initiation module 211 in one possible embodiment. As shown in FIG. 6B, user interface 620 is comparable to user interface 520.

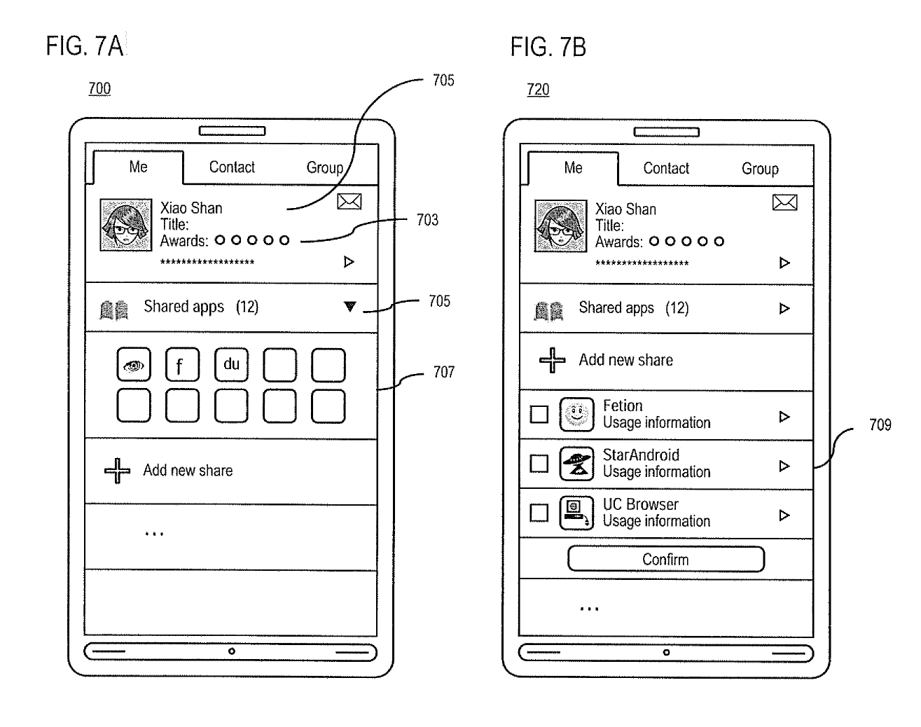

FIG. 7A user interface 700 is one possible display for the user to select the applications he/she would like to share with the contacts. For one embodiment, the user may have a profile 701. The profile may include metrics 703 as to the number of applications shared by the user, or the amount of sharing operations done by the user, such as downloading, tweeting, etc. In one embodiment, metrics 703 may be associated with ways to incentivize more sharing, such as coupons, money, special access to perks, etc. It may follow then, that the metrics 703 may be updated according to the user's activity. In exemplary scenarios, the user may view user interface 700 to change sharing settings and/or to check award metrics.

User interface 720 in FIG. 7B may also include the application overview thumbnail and listing of local applications shared to remind the user of the application or permit the user to show their opinion or interaction with the application. One such showing of the opinion may be usage information 709.

The processes described herein for sharing installed items may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to share installed items as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of sharing installed items.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to sharing installed items. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for sharing installed items. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for sharing installed items is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for sharing installed items to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to share installed items as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of sharing installed items.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a inure general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to share installed items. The memory 905 also stores the data associated with or generated by the execution of the inventive steps.

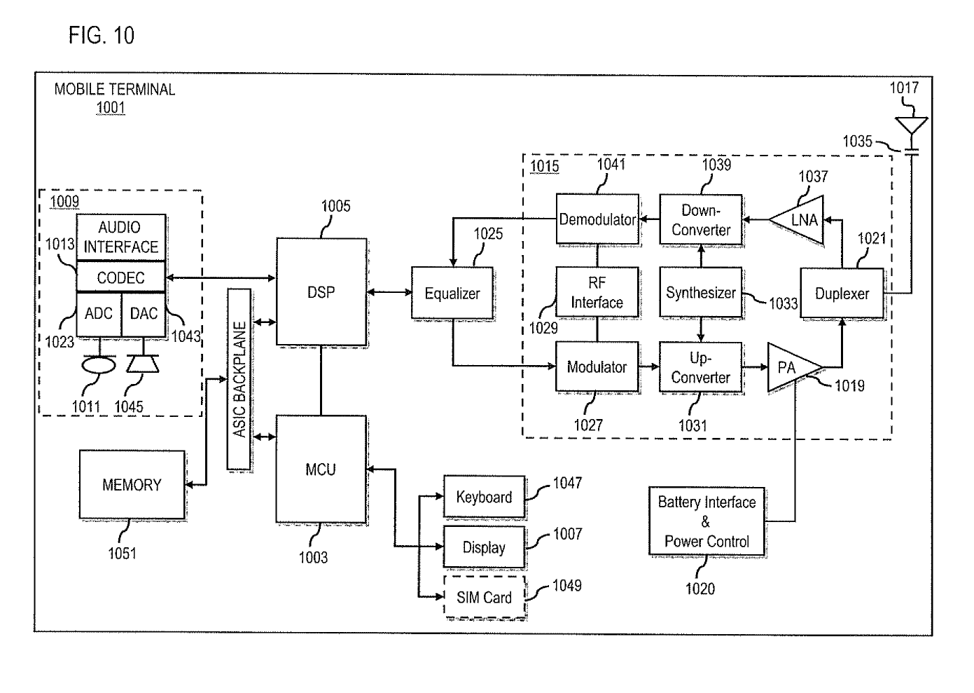

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of sharing installed items. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of sharing installed items. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to share installed items. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. A method comprising facilitating a processing of and/or processing (1) data and/or (2) information and/or (3) at least one signal, the (1) data and/or (2) information and/or (3) at least one signal based, at least in part, on the following:
at least one determination of one or more items installed on one or more devices;
a processing of the one or more items to cause, at least in part, an association of the one or more items with respective contact entries associated with the one or more devices, one or more users of the one or more devices, or a combination thereof; and
a rendering of one or more representations of the one or more items in a contact-based user interface based, at least in part, on the association.

40. A method of claim 39, wherein the (1) data and/or (2) information and/or (3) at least one signal are further based, at least in part, on the following:
a receiving of an input for selecting at least one of the one or more representations in the contact-based user interface; and
a processing of the input to cause, at least in part, one or more sharing operations.

41. A method of claim 40, wherein the one or more sharing operations include, at least in part, a rendering, an option to share the item, buying the item, or some combination thereof.

42. A method of claim 39, wherein the (1) data and/or (2) information and/or (3) at least one signal are further based, at least in part, on the following:
at least one determination of usage information, commenting information, one or more display criteria, one or more privacy policies, one or more security policies, or a combination thereof associated with the one or more content items, the one or more devices, the one or more users, or a combination thereof,
wherein the rendering of the one or one or more representations, the contact-based user interface, or a combination thereof is based, at least in part, on the usage information, the commenting information, the one or more display criteria, the one or more privacy policies, the one or more security policies or a combination thereof.

43. A method of claim 42, wherein the usage information includes, at least in part, the total time that the user has been using the application, the frequency that the user has used the application, average usage time each day, usage specific to the item itself, or a combination thereof.

44. A method of claim 39, wherein the (1) data and/or (2) information and/or (3) at least one signal are further based, at least in part, on the following:
a processing of the contact entries associated with the one or more devices, the one or more users of the one or more devices, or a combination thereof into one or more groups,
wherein the rendering is based, at least in part, on the one or more groups.

45. A method of claim 39, wherein the (1) data and/or (2) information and/or (3) at least one signal are further based, at least in part, on the following:
at least one determination of advertising information, one or more related items, or a combination thereof based, at least in part, on the association,
wherein the rendering, the contact-based user interface, or a combination thereof include, at least in part, the advertising information, the one or more related items, or a combination thereof.

46. A method of claim 39, wherein the (1) data and/or (2) information and/or (3) at least one signal are further based, at least in part, on the following:
a monitoring of the one or more devices to determine the one or more items,
wherein the monitoring is performed periodically, according to a schedule, on demand, or a combination thereof.

47. A method of claim 46, wherein the one or more items includes, at least in part, applications, bookmarks, playlists, ringtones, personal settings, and/or device properties, or a combination thereof.

48. An apparatus comprising:
at least one processor; and
at least one memory including computer program code for one or more programs,
the at least one memory and the computer program code configured to, with the at least one processor, cause the apparatus to perform at least the following,
determine one or more items installed on one or more devices;
process and/or facilitate a processing of the one or more items to cause, at least in part, an association of the one or more items with respective contact entries associated with the one or more devices, one or more users of the one or more devices, or a combination thereof; and
cause, at least in part, a rendering of one or more representations of the one or more items in a contact-based user interface based, at least in part, on the association.

49. An apparatus of claim 48, wherein the apparatus is further caused to:
receive an input for selecting at least one of the one or more representations in the contact-based user interface; and
process and/or facilitate a processing of the input to cause, at least in part, one or more sharing operations.

50. An apparatus of claim 49, wherein the one or more sharing operations include, at least in part, a rendering, an option to share the item, buying the item, or some combination thereof.

51. An apparatus of claim 48, wherein the apparatus is further caused to:
determine usage information, commenting information, one or more display criteria, one or more privacy policies, one or more security policies, or a combination thereof associated with the one or more content items, the one or more devices, the one or more users, or a combination thereof,
wherein the rendering of the one or one or more representations, the contact-based user interface, or a combination thereof is based, at least in part, on the usage information, the commenting information, the one or more display criteria, the one or more privacy policies, the one or more security policies or a combination thereof.

52. The apparatus of claim 51, wherein the usage information includes, at least in part, the total time that the user has been using the application, the frequency that the user has used the application, average usage time each day, usage specific to the item itself, or a combination thereof.

53. An apparatus of claim 48, wherein the apparatus is further caused to:
process and/or facilitate processing of the contact entries associated with the one or more devices, the one or more users of the one or more devices, or a combination thereof into one or more groups,
wherein the rendering is based, at least in part, on the one or more groups.

54. An apparatus of claim 48, wherein the apparatus is further caused to:
determine advertising information, one or more related items, or a combination thereof based, at least in part, on the association,
wherein the rendering, the contact-based user interface, or a combination thereof include, at least in part, the advertising information, the one or more related items, or a combination thereof.

55. An apparatus of claim 48, wherein the apparatus is further caused to:
cause, at least in part, a monitoring of the one or more devices to determine the one or more items,
wherein the monitoring is performed periodically, according to a schedule, on demand, or a combination thereof.

56. An apparatus of claim 55, wherein the one or more items includes, at least in part, applications, bookmarks, playlists, ringtones, personal settings, and/or device properties, or a combination thereof.

57. A computer program product including one or more sequences of one or more instructions which, when executed by one or more processors, cause an apparatus to at least perform the steps:
determining one or more items installed on one or more devices;
processing and/or facilitating a processing of the one or more items to cause, at least in part, an association of the one or more items with respective contact entries associated with the one or more devices, one or more users of the one or more devices, or a combination thereof; and
causing, at least in part, a rendering of one or more representations of the one or more items in a contact-based user interface based, at least in part, on the association.

58. A computer program product of claim 57, wherein the apparatus is caused, at least in part, to further perform:
receiving an input for selecting at least one of the one or more representations in the contact-based user interface; and
processing and/or facilitating a processing of the input to cause, at least in part, one or more sharing operations.
